(19) United States
(12) Patent Application Publication
(10) Pub. No.: US 2021/0350259 A1
(43) Pub. Date: Nov. 11, 2021

(54) DATA PROCESSING SYSTEMS AND METHODS TO PROVIDE DECISION SUPPORT

(71) Applicant: Nowcasting.ai, Inc., New York, NY (US)

(72) Inventors: Damian Scavo, Assisi (IT); Loris D'Acunto, Palo Alto, CA (US)

(21) Appl. No.: 17/246,252

(22) Filed: Apr. 30, 2021

Related U.S. Application Data
(60) Provisional application No. 63/021,550, filed on May 7, 2020.

(51) Int. Cl. G06N 5/04; G06N 20/00

(52) U.S. Cl. CPC G06N 5/04; G06N 20/00

(57) ABSTRACT

A method for determining present or future trends, and providing a recommendation based on those trends includes receiving raw data from one or more sources, where the raw data is data which has not been cleaned or normalized, cleaning and normalizing the raw data, creating historic data via machine learning, comparing the cleaned and normalized data with the historic data, generating a model based on the compared cleaned and normalized data and the historic data, wherein the model generates one or more determinations, and providing the one or more determinations for use by a recommendation engine or a user. Additionally, a method of collecting specific data includes receiving a survey and additional information provided by a panelist on a mobile application, filtering and organizing the panelists, storing the collected information, providing the stored data to a server for cleaning and normalizing, and providing the panelist with rewards.

### CROSS-REFERENCE TO RELATED APPLICATIONS

This application is a Utility application of U.S. Provisional Application No. 63/021,550 filed May 7, 2020, the contents of which are incorporated herein by reference.

### BACKGROUND

### Field

The present disclosure relates to systems and methods for measuring data (e.g., revenue) and determining present and future trends, and providing a recommendation based on the measured data and determined trends.

### Related Art

In related art systems, data analysts typically study and analyze trends in economic data manually. For example, these analysts may study data in order to determine when to buy or sell a stock manually, or what the unemployment rate looks like at any given period.

However, the data used to determine these metrics may be unreliable due to the lack of availability of such proprietary information. For example, data which should not necessarily be correlated with a particular economic metric may not have been filtered out when analyzing the data, thereby introducing inaccuracies within the analysis.

Thus, there is a need for reliable data, and reliable methods for analyzing the data to determine present and future trends in this data.

### SUMMARY OF THE DISCLOSURE

Aspects of the present disclosure include a method for determining trends in a set of data, and providing a recommendation based on those determined trends. Examples of trends which are analyzed may include recommending when to buy or sell a stock associated with one or more companies. Other metrics may be determined, including a regional, national, or universal unemployment rate, public and not public company revenues and market shares, consumer behavior across several companies, a basket of stocks (e.g., more than one particular stock such as an entire stock portfolio), electronic indices, restaurant indices, how particular sectors in the workforce are performing, inflation, and trends for mutual funds. In particular, anything which may have an economic impact may be measured.

This method may include receiving data from a data supplier related to one or many companies. This data may include specific sales information, for example. This data may then be normalized and associated with the company based on the company's public trade name, for example.

Once this data is cleaned and normalized, this data may be associated with data, including but not limited to financial data. Financial data may include historical data for a company at quarterly increments, fiscal data, merger and acquisition (M&A) data, and current analyst data, for example However, the present example implementations are not limited thereto, and other data, directed to other fields or industries, may be substituted therefor, or combined therewith, without departing from the inventive scope.

Once the data is cleaned and normalized, and then associated with the financial data, a recommendation model may be generated using machine learning, based on the normalized information and the normalized historical data. Various machine learning algorithms may be applied in order to find the best fit for the generated model in order to generate a prediction for how the company, or other measured trend may behave at the present, e.g., today, or in the future. Optionally, a user may review the one or more determinations and make a decision or recommendation.

These machine learning algorithms, or recommendation models, enable a user to determine to make a recommendation as to when to take on a particular transaction, such as buying or selling a stock, for example. Various features are integrated into the recommendation models, including statistical analysis, correlations, and historic simulation.

Once a trading statistic model is fit to the revenue curve, a signal or indicator may be generated and provided, indicating whether the user should buy, sell, or do nothing. For example, the indicators may include a “strong buy”, indicating that the user should buy the stock soon. Another indicator may include a “strong sell”, indicating that the user should sell soon. The signal may also indicate how much stock to buy/sell, or when to buy/sell a stock, for example.

Additionally, to collect data, a private panel of users may be organized, wherein the users interact with a mobile application which collects user data and gives rewards in return (e.g., a cash-back app).

Further aspects of the present application may include a non-transitory computer readable medium having stored therein a program for making a computer execute a method of determining trends and generating a recommendation based on those trends. The method includes operations associated with the features disclosed in the detailed description.

Additional aspects of the present application may include a server apparatus having a memory and a processor. The memory may store collected data and historical data. The processor may execute a process including operations associated with the features disclosed in the detailed description.

When the one or more sources comprises panelists, the filtering comprises receiving a pool of fragmented users; filtering the pool of fragmented users based on geolocation to remove one or more of the fragmented users until the pool of fragmented users is representative of a population distribution associated with a geographical unit, to generate a first filtered pool of fragmented users; filtering the first filtered pool of fragmented users based on a stable number of transactions from a start date to an end date, to obtain a second filtered pool of fragmented users;

removing outliers and duplicates from the second filtered pool of fragmented users to generate the filtered panelists.

The normalizing comprises transforming the collected and stored additional data from a text format into a distributed database that operates on transactions associated with the stored and collected additional data, and the cleaning comprises removing a portion of the stored and collected additional data that is not required, including data associated with incomplete transactions and duplicated data, to generate the cleaned, normalized data.

According to some aspects, after the normalizing and cleaning, aspects of the example implementations include classifying the cleaned, normalized data by analyzing descriptions of the transactions, and associating merchant identifiers with the corresponding descriptions, wherein an automated machine learning is applied to reach an accuracy, to generate classified data.

Further aspects include, for a panel comprising the filtered panelists, combining the classified data and third party data to generate initial forecasts that are assembled into a final forecast based on differences in consumer behavior associated with corresponding differences in revenue structure for the merchant identifiers, wherein the final forecast comprises a prediction of a future value of a parameter associated with the merchant identity, performing bias calculation of non-randomized panelists, and performing a correction to the initial forecasts based on the bias calculation.

Other aspects include detecting one or more anomalies for an output of each of the cleaning, the normalizing, the classifying and the generating, based on anomalies in a behavior of the merchant associated with the merchant identifier, and/or based on a statistical error of the additional data from the panelists.

Still further aspects of the present application may include a server apparatus. The server apparatus may include means for storing collected data and historical data, means for executing operations to achieve functions operations associated with the features disclosed in the detailed description.

### BRIEF DESCRIPTION OF THE DRAWINGS

Exemplary implementation(s) of the present invention will be described in detail based on the following figures, wherein:

FIG. 1 illustrates a flowchart of a process for generating a recommendation according to an example implementation of the present application.

FIG. 2 illustrates a flowchart of a process for cleaning and normalizing data according to an example implementation of the present application.

FIG. 3 illustrates a flowchart of a process for collecting information through a mobile application.

FIG. 4 illustrates an example environment according to an example implementation of the present application.

FIG. 5 illustrates an example computing environment with an example computer device suitable for use in some example implementations.

FIGS. 6-10 illustrate various example implementations.

FIGS. 11A-11B illustrate various example implementations.

FIGS. 12-13 illustrate various example implementations.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or operator control over certain aspects of the implementation, depending on the desired implementation of one of ordinary skill in the art practicing implementations of the present application.

With a more complex and dynamic economy, there is a need for accurate data reflecting exactly what is going on in the economy at any given point in time. More specifically, in order to accurately determine the current state of the economy, to then be able to determine present and future trends in the economy, accurate data is required so that the recommendation itself is accurate.

For example, when considering purchasing a particular stock, a trader may consider corporate information related to the company associated with the stock. This corporate information may include, at a very high level, how much revenue a company is taking in, how much money the company lost for a particular period of time (e.g., quarter, month, year).

However, this general, broad data is often not an accurate depiction of how a company is actually behaving. For example, revenue for a clothing company may appear to be high overall, but when the data is broken down, the revenue may be coming from online sales primarily. Typically, stores with higher revenue from online sales end up closing several brick and mortar stores, because those stores are no longer profitable. Thus, a trader who is considering to buy that clothing company's stock may not want to purchase that stock if they know that those stores will likely close at a future point in time.

Unfortunately, without accurate data, a trader has little way of knowing how a particular trend will look in the future. Therefore, by collecting data and cleaning and normalizing that data, this cleaned data may be compared to historical data to determine how a particular trend will look in the future. Similarly, a trader may also not be able to assess present information, to make a decision or recommendation. According to the present example implementations, the cleaned data may be present data that is compared to historical data, to provide an analysis of current trends.

While the above example implementation describes determining trends related to the stock market, other metrics may be determined (e.g., obtained deterministically), including a regional, national, or universal unemployment rate, public and not public company revenues and market shares, consumer behavior across several companies, a basket of stocks (e.g., more than one particular stock such as an entire stock portfolio), electronic indices, restaurant indices, how particular sectors in the workforce are performing, inflation, and trends for mutual funds. In particular, any data or information which may have an economic impact may be measured.

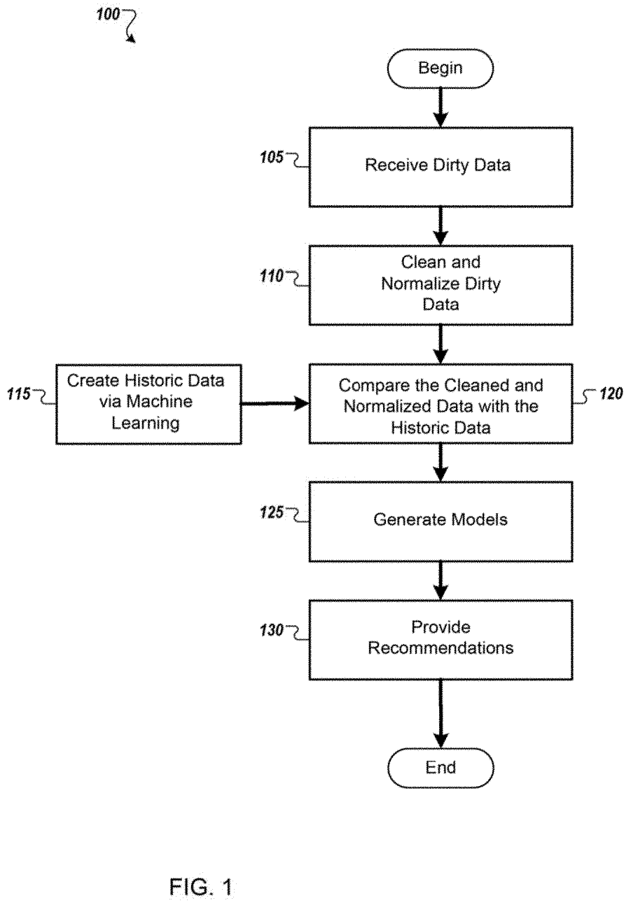

As shown in FIG. 1, a process 100 for generating one or more determinations (e.g., a determination) and one or more recommendations (e.g., a recommendation) may begin by receiving “raw” data (e.g., data which has not yet been cleaned) at 105. This raw data may then be cleaned and normalized at 110.

Simultaneously, or at a previous time, historic data may be gathered and organized via machine learning at 115. Then, at 120, this data may be compared with the historic data.

At 125, models may be generated to determine the best recommendation or evaluation of a particular trend. Then, at 130, the recommendation(s) may be provided.

### Data Collection

In order to be able to accurately determine how a particular trend will look, various sources of data may be used. For example, a panel of individuals with particular qualifications or certifications may be organized in order to obtain data about their day to day transactions. This panel may be created by way of a mobile application, discussed in more detail in a later portion of this disclosure. Additionally, data may be anonymously crowd-sourced.

This data needs to be very specific and precise, for each and every transaction assessed. For example, information about the date of the transaction, the location that the transaction was undertaken, a description of the transaction, the amount of the transaction, how the transaction was paid for, and the identity of the person who undertook the transaction may be analyzed to help obtain and determine a particular trend.

Other data may be collected as well, including Global Positioning System (GPS) information, WiFi information, Bluetooth data, and the like. This data may be associated with a particular store or user identification based on the IP address or associated location data. Additionally, latitudinal and longitudinal data may be collected, as well as a time stamp of when that latitudinal and longitudinal data was collected.

Further, information related to a particular website which was visited by a user may be collected, including what web pages were viewed, a timestamp corresponding to a time that the website was visited, and how long the user spent on the website or each web page.

Mobile application usage data may also be tracked, including what features were viewed, a timestamp corresponding to a time that the application was visited, and how long the user spent on the application. This application usage data may be associated with a particular device identification, in order to further track and collect data.

Other relevant data may also be collected and analyzed for other metrics, including a regional, national, or universal unemployment rate, quarter revenues, sales trends of public and non-public companies, such as public and not public company revenues and market shares, consumer behavior across several companies, a basket of stocks (e.g., more than one particular stock such as an entire stock portfolio), electronic indices, restaurant indices, how particular sectors in the workforce are performing, inflation, and trends for mutual funds.

For example, employment data for a particular person may be collected in order to determine employment rate, or restaurant transactions may be collected and monitored to determine restaurant indices.

This collected data will be referred to as “raw data” hereafter, because this data has not yet been cleaned and normalized.

### Data Cleanup

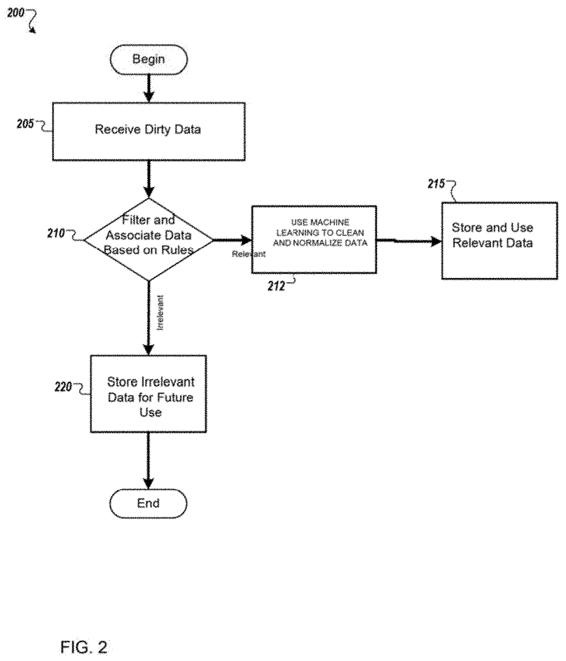

FIG. 2 illustrates a flowchart of a process for cleaning and normalizing data according to an example implementation of the present application. At step 205, raw data may be received. Then, at step 210, this raw data may be filtered based on particular assigned rules, and then the data may be associated with particular metrics; further, a determination is made as to whether the data is characterized as relevant.

For example, according to the example implementations, in a credit card transaction that may be associated with a payment at a restaurant for a purchase (e.g., food), the description may include “tacob” in the description. The Example implementation may use assigned rules and metrics to assign a value of “taco” to “tacob”. Alternatively, the data may be filtered, such that description is transformed to “taco”. Depending on the circumstances, data that cannot be filtered based on the rules may be deleted.

If the filtered and associated data is considered to be relevant, then at 212, for the data determined to be relevant, machine learning is applied, to clean and normalize the data, and this data is stored and utilized in the process 100 at 215. If the filtered and associated data is considered to be irrelevant, then the data may be stored for future use at 220.

Once the raw data has been collected, this raw data may be cleaned and normalized to strengthen the value of the data. For example, the data may be associated with a particular stock. In an example implementation, if a user purchased food from Taco Bell, then the transaction may be associated with the Taco Bell stock. Alternatively, if a user visited Instagram or Facebook, that interaction may be associated with the Facebook stock, for example.

This raw data needs to be normalized to remove data which, on its face, is not wholly accurate. For example, if data related to a Walmart transaction is associated with the Walmart stock, then transactions which were completed on a Chase credit card may be filtered out in order to keep only transactions which were completed on the Walmart card. This filtering process helps to ensure that the data associated with the particular stock is an accurate depiction of the relationship between the company and a user/consumer.

This cleaning and normalizing process may be applied to the other metrics in other example implementations, including a regional, national, or universal unemployment rate, public and not public company revenues and market shares, consumer behavior across several companies, a basket of stocks (e.g., more than one particular stock such as an entire stock portfolio), electronic indices, restaurant indices, how particular sectors in the workforce are performing, inflation, and trends for mutual funds. For example, unemployment data may be filtered based on demographic information or geographic information, in order to accurately determine behavior in a particular area.

### Model Generation and Application Based on Machine Learning

Once the raw data has been cleaned and normalized, models may be generated using machine learning in order to correlate historical data with the cleaned and normalized data. Months or years of historical data may be collected in order to establish this correlation.

Machine learning may be used to generate a result of the correlation, indicating the best combination or rules which would best represent the behavior of a particular metric. For example, once the data is correlated with historical data, machine learning algorithms may be applied to the data to determine how one or more companies is expected to behave, and provide such information to a user, such as for a recommendation engine or the like, but not limited thereto.

These one or more determinations may be provided for each quarter, and then the current or next quarter may be predicted using the machine learning algorithms. Then, the algorithm having the best fit may be selected, in order to provide for the best prediction.

This machine learning output is then fed into a recommendation model. These operations may be performed iteratively, such that a greater number of iterations results in increased accuracy of the best fit, and the corresponding determination.

In the recommendation model, a recommendation may be provided, suggesting when to take a particular action, or how a particular trend is expected to look at a given point in time in the future, in addition to providing relevant information regarding the current trend.

For example, based on historical data of a stock and the related stock index, a recommendation may be provided for which stock to buy or sell, when to buy or sell the stock, and how much to buy or sell. Alternatively, the recommendation model may illustrate how well a business or restaurant is expected to perform at a future point in time, as well as how the business or restaurant is currently performing, with an increased degree of accuracy. One or more appropriate recommendations (e.g., expand business coverage, maintain current inventory, decrease new orders) may be made with an increased degree of accuracy.

### Mobile Application for Collecting Data

As described in an earlier portion of this disclosure, a mobile application may be provided to a group of users in order to collect data. This mobile application may be used across various devices with computing capabilities, including smartphone, smart watches, and virtual assistants, for example.

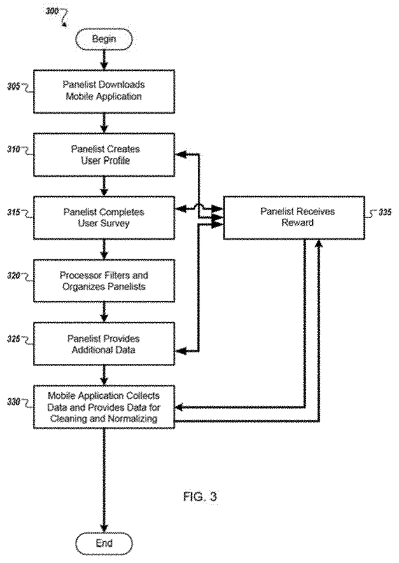

As shown in FIG. 3, a panelist may download a mobile application at 305. Then, the panelist may create a user profile at 310. The panelist may then complete a user survey at 315, providing demographic data, gender and age information, and other related information.

The mobile application may function as a rewards application, where a panelist is given rewards based on accomplished tasks at 335. For example, a panelist may be given a reward for downloading the application and joining the rewards program. The panelist may also receive a reward for completing the user survey at 315.

These rewards may include giving cash back, providing discount codes, allowing access to certain application functionality, providing lottery tickets and other prizes, giving direct money back on a debit card or via a peer-to-peer mobile application such as Venmo or Cash App, or providing gift cards to a panelist.

Points may be earned daily, and every time a number of points exceeds a certain threshold, a reward corresponding to that point value may be offered to the panelist. These points may be awarded passively as well. For example, a panelist may leave their profiles active, without physically interacting with the account, and still be issued rewards. Rewards may also change based on the amount of money spent on a particular transaction.

Once the panelist downloads the mobile application at 305 and creates a user profile for joining the rewards program at 310, the panelist may take a survey at 315; as explained above, upon joining the rewards program at 310 and/or taking the survey at 315, the panelist may receive a reward at 335, and return to the process, as indicated by the two-way arrows in FIG. 3. This survey may ask a panelist about various pieces of information, including demographic information, gender, age, marital status, etc.

When questions in the survey have been filled out, the application may automatically filter and sort the panelist based on the provided information at 320. This filtering process helps to calibrate the data, in order to adequately represent the population of panelists, as applied to the real world.

Based on what metrics are being measured, the mobile application may decide a panel size, in order to provide statistically significant data. This panel size may change based on what is being tracked, including stock information, a regional, national, or universal unemployment rate, public and not public company revenues and market shares, consumer behavior across several companies, a basket of stocks (e.g., more than one particular stock such as an entire stock portfolio), electronic indices, restaurant indices, how particular sectors in the workforce are performing, inflation, and trends for mutual funds.

This data may be updated periodically or automatically. For example, the mobile application may consider mortality, changes in user information or user demographics, in order to further filter and organize the panelists, to maintain the panel's statistical relevance.

A panelist may also provide other information at 325, aside from the survey, to receive additional rewards at 335, and return to the process, as indicated by the two-way arrows. For example, a panelist may connect their credit card and banking information to the application via an application programming interface (API) software and third party APIs.

Based on this information, the mobile application may track, for example, information about the date of a transaction, the location that the transaction was undertaken, a description of the transaction, the amount of the transaction, how the transaction was paid for, and the identity of the person who undertook the transaction may be analyzed to help determine a particular trend. Additionally, the mobile application may be provided with an interface or a functionality to provide one or more queries to the user. For example, the user may be queried for additional information if the current information is not sufficient, or to generate additional information or analysis (e.g., statistic survey).

Other data may be collected as well, including GPS, WiFi, Bluetooth data, and the like. This data may be associated with a particular store or user identification based on the IP address or associated location data. Additionally, latitudinal and longitudinal data may be collected, as well as a time stamp of when that latitudinal and longitudinal data was collected.

Further, information related to a particular website which was visited by a user may be collected, including what web pages were viewed, a timestamp corresponding to a time that the website was visited, and how long the user spent on the website or each web page.

Mobile application usage data may also be tracked, including what features were viewed, a timestamp corresponding to a time that the application was visited, and how long the user spent on the application. This application usage data may be associated with a particular device identification, in order to further track and collect data.

Once the mobile application has collected the data from the panelist, tracked relevant metrics, and filtered the panelists, the mobile application may provide the data as raw data to be cleaned and normalized at 330. An iterative loop is performed between providing the cleaned, normalized data at 330 and rewarding the panelist at 335, as shown in FIG. 3. The operations of FIG. 3 may continue iteratively, until the process is terminated by the online application and/or the panelist.

### Example Environment

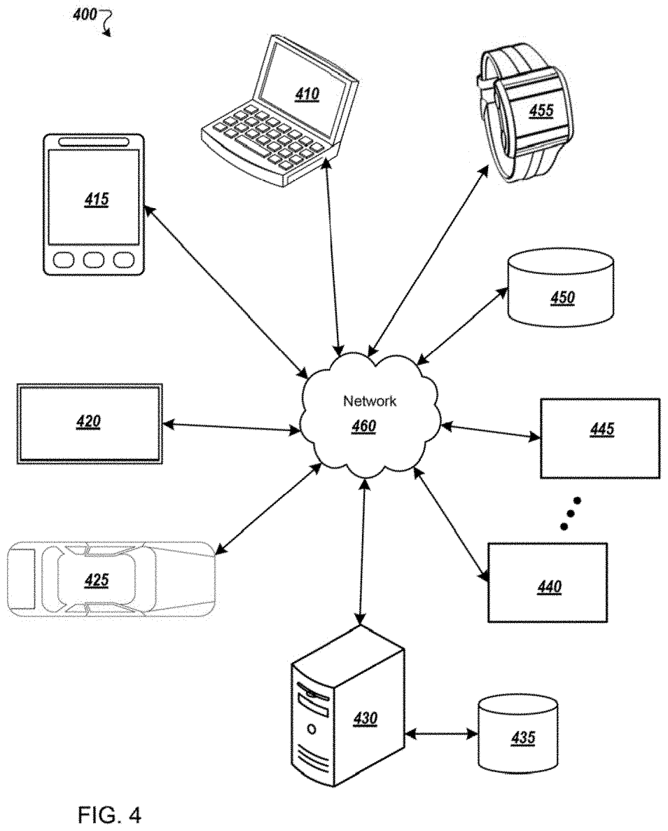

FIG. 4 shows an example environment suitable for some example implementations. Environment 400 includes devices 410-455, and each is communicatively connected to at least one other device via, for example, network 460 (e.g., by wired and/or wireless connections). Some devices may be communicatively connected to one or more storage devices 440 and 445.

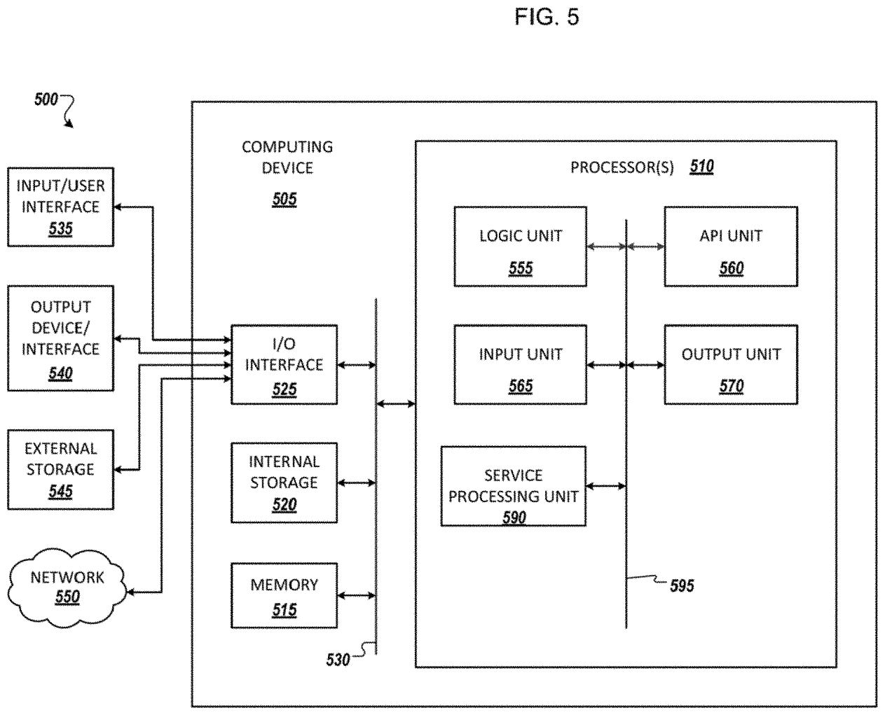

An example of one or more devices 410-455 may be computing devices 55 described in FIG. 5, respectively. Devices 405-455 may include, but are not limited to, a computer 410 (e.g., a laptop computing device) having a monitor, a mobile device 415 (e.g., smartphone or tablet), a television 420, a device associated with a vehicle 425, a server computer 430, computing devices 435 and 450, storage devices 440 and 445, and smart watch or other smart device 455.

In some implementations, devices 410-425 and 455 may be considered user devices associated with the users of the enterprise. Devices 430-450 may be devices associated with service providers (e.g., used by the external host to provide services as described above and with respect to the collecting and storing data).

### Example Computing Environment

FIG. 5 shows an example computing environment with an example computing device suitable for implementing at least one example embodiment. Computing device 505 in computing environment 500 can include one or more processing units, cores, or processors 510, memory 515 (e.g., RAM, ROM, and/or the like), internal storage 520 (e.g., magnetic, optical, solid state storage, and/or organic), and I/O interface 525, all of which can be coupled on a communication mechanism or bus 530 for communicating information. Processors 510 can be general purpose processors (CPUs) and/or special purpose processors (e.g., digital signal processors (DSPs), graphics processing units (GPUs), and others).

In some example embodiments, computing environment 500 may include one or more devices used as analog-to-digital converters, digital-to-analog converters, and/or radio frequency handlers.

Computing device 505 can be communicatively coupled to input/user interface 535 and output device/interface 540. Either one or both of input/user interface 535 and output device/interface 540 can be wired or wireless interface and can be detachable. Input/user interface 535 may include any device, component, sensor, or interface, physical or virtual, which can be used to provide input (e.g., keyboard, a pointing/cursor control, microphone, camera, Braille, motion sensor, optical reader, and/or the like). Output device/interface 540 may include a display, monitor, printer, speaker, braille, or the like. In some example embodiments, input/user interface 535 and output device/interface 540 can be embedded with or physically coupled to computing device 505 (e.g., a mobile computing device with buttons or touch-screen input/user interface and an output or printing display, or a television).

Computing device 505 can be communicatively coupled to external storage 545 and network 550 for communicating with any number of networked components, devices, and systems, including one or more computing devices of the same or different configuration. Computing device 505 or any connected computing device can be functioning as, providing services of, or referred to as a server, client, thin server, general machine, special-purpose machine, or another label.

I/O interface 525 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 500. Network 550 can be any network or combination of networks (e.g., the Internet, local area network, wide area network, a telephonic network, a cellular network, satellite network, and the like).

Computing device 505 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computing device 505 can be used to implement techniques, methods, applications, processes, or computer-executable instructions to implement at least one embodiment (e.g., a described embodiment). Computer-executable instructions can be retrieved from transitory media, and stored on and retrieved from non-transitory media. The executable instructions can be originated from one or more of any programming, scripting, and machine languages (e.g., C, C++, C #, Java, Visual Basic, Python, Perl, JavaScript, and others).

Processor(s) 510 can execute under any operating system (OS) (not shown), in a native or virtual environment. To implement a described embodiment, one or more applications can be deployed that include logic unit 555, application programming interface (API) unit 560, input unit 565, output unit 570, service processing unit 590, and inter-unit communication mechanism 595 for the different units to communicate with each other, with the OS, and with other applications (not shown). For example, service processing unit 990 may implement one or more processes described above. The described units and elements can be varied in design, function, configuration, or implementation and are not limited to the descriptions provided.

In some example embodiments, when information or an execution instruction is received by API unit 560, it may be communicated to one or more other units (e.g., logic unit 555, input unit 565, output unit 570, service processing unit 590). For example, input unit 565 may use API unit 560 to connect with other data sources so that the service processing unit 590 can process the information. Service processing unit 590 performs the filtering of panelists, the filtering and cleaning/normalizing of data, and generation of the results, as explained above.

In some examples, logic unit 560 may be configured to control the information flow among the units and direct the services provided by API unit 565, input unit 570, output unit 575, media identifying unit 580, media processing unit 585, service processing unit 590 in order to implement an embodiment described above. For example, the flow of one or more processes or implementations may be controlled by logic unit 960 alone or in conjunction with API unit 565.

According to the foregoing example implementations, users are sourced to create a panel. As provided herein, a panel may be selected according to the following selection process.

An optimal panel to be used for forecast may be generated. More specifically, the selection process includes performing a filter operation on the candidate users for the panel. For example, but not by way of limitation, the filter operation may be performed by the application of a filter, so as to generate a panel meeting one or more criteria. According to the present example implementation, the criteria may include, but are not limited to, the panel including users that are representative of a population (e.g., US population) for their geolocation, with a substantially stable number of purchases from a starting date to an ending date (e.g., 2011 to the current date), with a consistent number of transactions. Optionally, outliers and duplicates may also be removed.

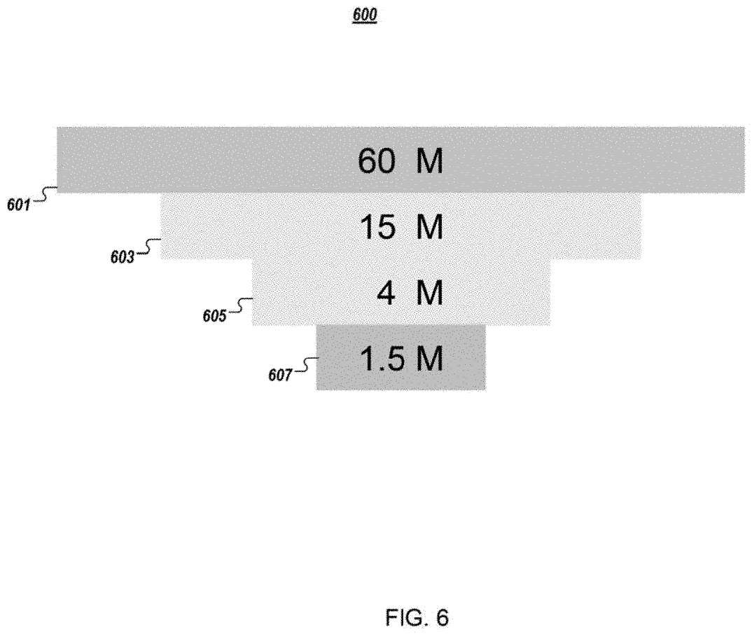

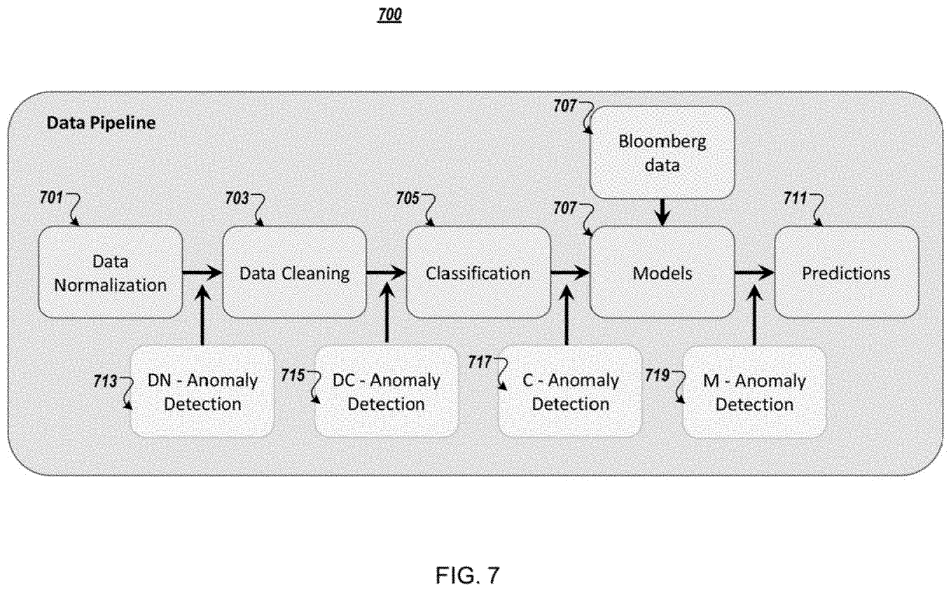

As shown in FIG. 6, a selection process 600 may be performed. Initially, the pool of candidate users is a fragmented panel consisting of 60 million users at 601. After a first filter process performs the filtering operation such that the pool of candidate users is representative of the population for their geolocation, the filtered pool is narrowed to 15 million users at 603. Subsequently, another filter operation is performed to confirm a stable number of purchases over a time interval, further narrowing the pool of candidate users to 4 million users at 605. At 607, outliers and duplicates may be removed, and a filter operation may be performed for a consistent number of transactions, to produce an optimal panel of 1.5 million users.

At 701, data normalization is performed. Data that is received from different institutions may have different structures. In order to properly use the data from the different institutions, the data must be normalized with a fixed format. More specifically, the data is transformed from a text format into a distributed database that is designed to operate on top of the transactions.

At 703, a data cleaning operation is performed. More specifically, the data that is not required or desired for the data processing pipeline 700 is removed. For example but not by way of limitation, duplicated transactions, duplicated accounts and duplicated users are identified and removed. Further, incomplete data, such as incomplete transactions with missing data, are also removed from the data. Accordingly, and as explained above with respect to panel selection, the base of users that follows the selection process and filter operation is maintained in the user database, and the outliers and duplicates are removed.

After the data cleaning 703 has been completed, a classification operation 705 is performed. In this operation, each of the transactions in the database is classified. The classification is performed by analyzing the description of the transaction, and associating a correct merchant name with the description. In this operation, the quality of the association directly and critically influences the quality of the correlation and rejections that will be described further below. More specifically, to reach a desired accuracy, such as close to 100%, a combination of automated machine learning algorithms is combined with manual human controls.

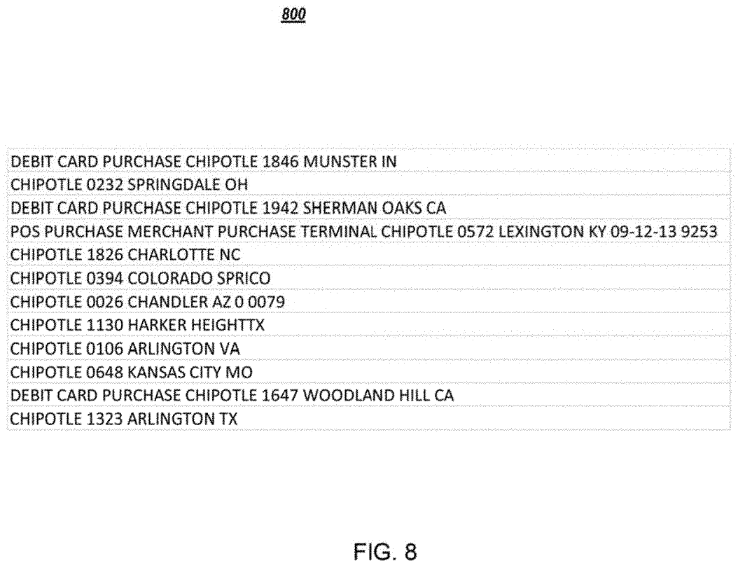

As an example of the foregoing classification operation 705, an example extract is provided. According to one example implementation, an average monthly volume of processing may be more than 200 million transactions; each of those transactions must be associated with a correct company. FIG. 8 illustrates the example extract. As can be seen in the example extract 800, the name of the merchant is found in each of the transactions.

Once the cleaned data has been classified as explained above, a modeling operation 707 is performed. More specifically, the modeling operation 707 generates forecasts. As inputs, the modeling operation 707 applies data output from the classification 705, as well as third-party input, for example Bloomberg data 709. In the modeling operation 707, many forecasts are combined, to obtain an optimal results. The modeling operation 707 is specialized to a category associated with the company. Further, the modeling operation 707 compensates for various bias factors, such as seasonality and the like.

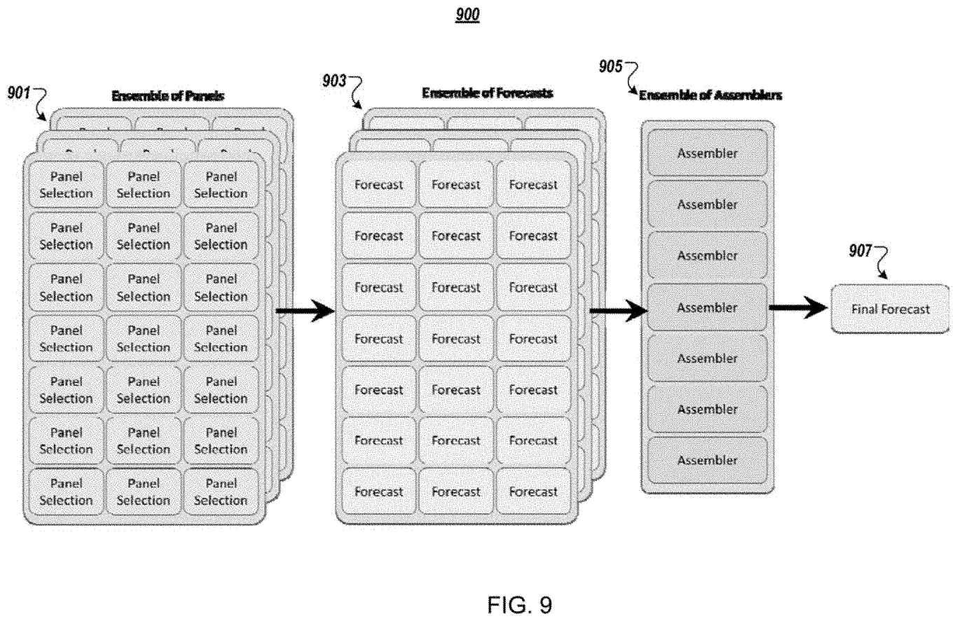

FIG. 9 illustrates an example implementation 900 associated with the modeling operation 707. More specifically, a plurality of sets of panels 901, subject to the foregoing operations of the data pipeline 700, are provided to the plurality of corresponding sets of forecasts 903; outputs of the sets of forecasts 903 are provided to plural assemblers 905, to generate a final forecast 907.

In the modeling operation 707, different categories of companies may require different algorithms to generate the forecasts. For, but not by way of limitation, the algorithms must incorporate the different behavior of consumers for the different structures of revenue within a company. Some of the categories may include, but are not limited to, fully owned restaurants, franchise restaurants, supermarket chains, insurance, and other companies.

The modeling operation 707 also provides for bias correction. For example but not by way of limitation, the panel data may include historical data of several years, from thousands of users that shared their data in exchange for a token or reward. Such an approach to obtaining the data allowed for a more complete understanding of the bias impacted by the panels that are not randomized, and algorithms for the correction of the bias.

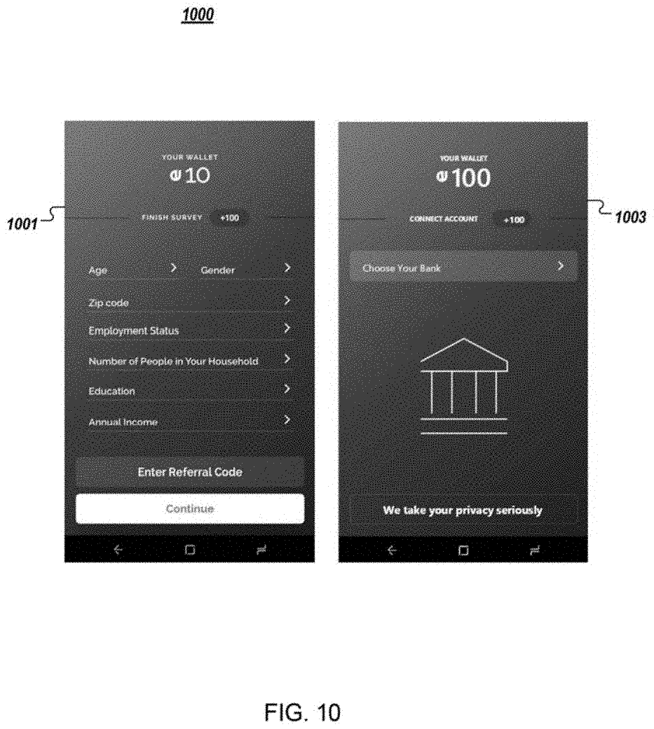

FIG. 10 illustrates a user experience 1000 associated with obtaining the information. At 1001, a user is provided with an input screen to input data and enter a referral code, as well as a number of points that may be associated with completing the survey. At 1003, the completion of the survey by the user results in the number of points being increased, and an option for selection of a bank where the points may be deposited, as well as a privacy statement.

To perform bias correction, historical data points are analyzed, to determine how the bias behaves across time. According to one example implementation, 9 algorithms were created for adjusting the bias in the data. Then, those 9 algorithms were combined with three other algorithms that are used for tickers, and that are less impacted by the bias.

At 711, an output of the modeling is provided to make predictions. More specifically, the data is aggregated and inserted in a database. The data in the database can be accessed and used by other rules, such as traders, and further retrieved for validation, back testing, etc.

Additionally, the data pipeline 700 includes anomaly detection 713-719. More specifically, an output of each of the elements of the data pipeline is subject to anomaly detection, to identify anomalies that may compromise final predictions. As an example of the anomaly detection 713-719, dataflow anomalies in the pipeline chain may examine technical anomalies as well as data anomalies. For example, but not by way of limitation, anomalies in the behavior of a company for which forecasting is being performed may be analyzed and provided, including, but not limited to the following:

1. Acquisitions or divestitures, sourced from third-party news sources

2. Changes in requirements that would result in different company behavior, such as accounting standards, sourced from, for example, but not by way of limitation, SEC (Securities and Exchange Commission) files.

3. Change in a ratio between franchisees and stores owned individually

4. A different duration of a quarter, such as changing from 90 days to 97 days

5. Special sales promotions or other promotional activities for weeks, which may vary from quarter to quarter

6. Releases of new products by companies.

According to an example implementation, representativeness is considered. More specifically, according to a specific example, in 2019 the US population was about 330 million individuals, with the average family size being 3.14 members, such that there are roughly 105 million families, some studies indicating the number to be as high as 128 million families. In the example implementations, the ratio between the number of US households and the best panel is roughly 70 to 85. Further, the ratio between the declared revenues of companies and the total amount of purchases in the panel is between about 70 and 90. This ratio is consistent with the expected value, and is consistent across different companies, such that the proportion of consumers is properly maintained the panels according to example implementations.

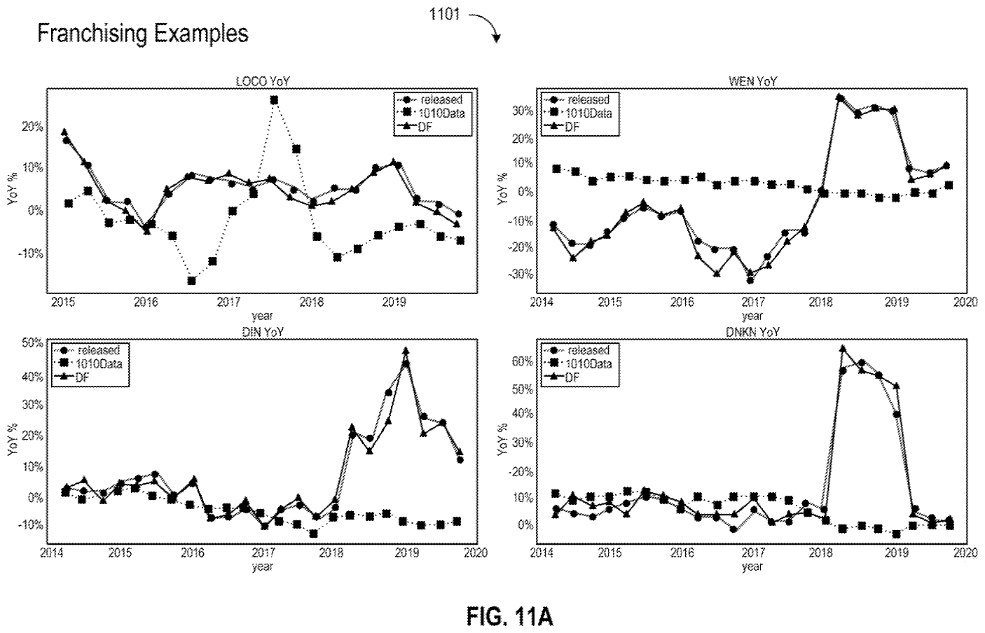

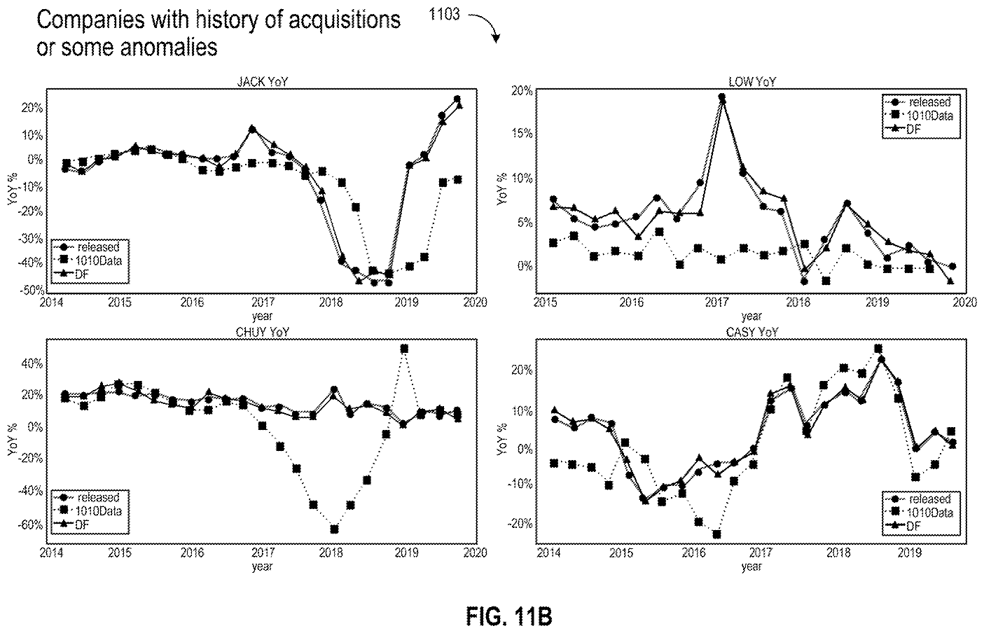

FIGS. 11A and 11B illustrate various examples of comparison with data. FIG. 11A includes franchising examples, and FIG. 11B includes examples of companies with a history of acquisitions, or anomalies.

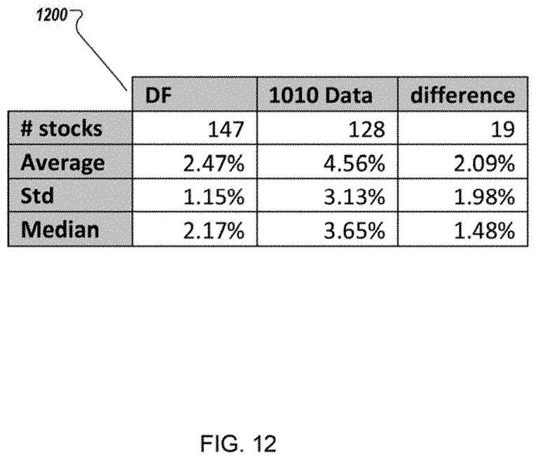

FIG. 12 illustrates a comparison between results according to the example implementations and the related art approaches. As can be seen in the column indicated as “DF” for the example implementations, and “1010 Data” for the related art approaches, a substantial difference in the forecasting results shows substantially improved performance for the example implementations.

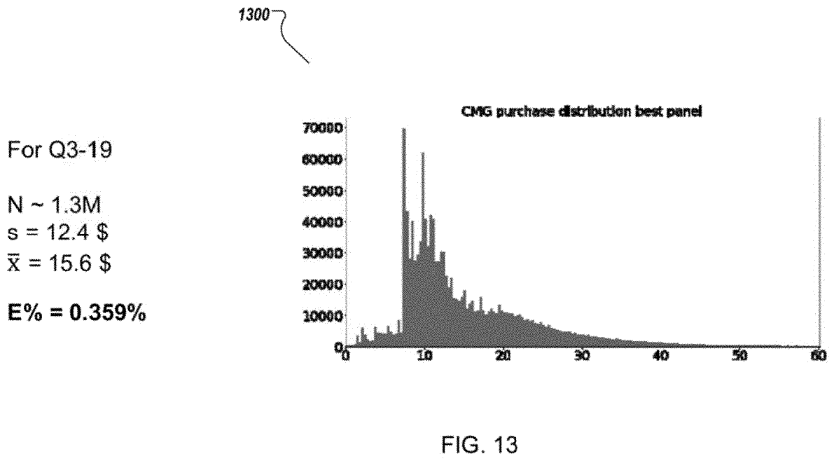

FIG. 13 illustrates the technical basis according to statistical methods for the determination of the panel size, and the measurement of the real statistical error.

From the central limit theorem, the theoretical % error for the forecast is given by

$$E \% ∝ \frac{1}{\sqrt{N}} \frac{s}{\overline{x}}$$

The Error % in the forecast is proportional to the sample standard deviation of the purchases and inverse to the square root of the purchase number and the average amount.

That means that the panel size is adequate to generate accurate predictions.

The real statistical error is even smaller, because we use the previously released revenues to correct and adjust the data.

Although a few example implementations have been shown and described, these example implementations are provided to convey the subject matter described herein to people who are familiar with this field. It should be understood that the subject matter described herein may be implemented in various forms without being limited to the described example implementations. The subject matter described herein can be practiced without those specifically defined or described matters or with other or different elements or matters not described. It will be appreciated by those familiar with this field that changes may be made in these example implementations without departing from the subject matter described herein as defined in the appended claims and their equivalents.

1. A computer-implemented method of determining a present or future trends, and providing a recommendation based on those trends, the method comprising:
receiving raw data from one or more sources, wherein the raw data is data which has not been cleaned or normalized;
cleaning and normalizing the raw data;
creating historic data via machine learning;
comparing the cleaned and normalized data with the historic data;
generating a model based on the compared cleaned and normalized data and the historic data, wherein the model determines the trend to generate one or more determinations; and
providing the one or more determinations for use in a recommendation engine, or by a user, to provide the recommendation.

2. The computer-implemented method of claim 1, wherein the cleaning and normalizing the raw data further comprises:
receiving the raw data;
filtering the raw data based on particular rules; and
associating the raw data with particular metrics,
wherein if the filtered and associated data is determined to be relevant, the data is stored and used as the cleaned and normalized data, and
wherein if the filtered and associated data is determined to be irrelevant, the data is stored for future use, and wherein the particular metrics include data associated with a particular stock or a plurality of stocks, a regional, national, or universal unemployment rate, public and not public company revenues and market shares, consumer behavior across several companies, electronic indices, restaurant indices, how particular sectors in the workforce are performing, inflation, and trends for mutual funds.

3. The computer-implemented method of claim 2, wherein the one or more sources comprises panelists, and the filtering comprises:
receiving a pool of fragmented users;
filtering the pool of fragmented users based on geolocation to remove one or more of the fragmented users until the pool of fragmented users is representative of a population distribution associated with a geographical unit, to generate a first filtered pool of fragmented users;
filtering the first filtered pool of fragmented users based on a stable number of transactions from a start date to an end date, to obtain a second filtered pool of fragmented users;
removing outliers and duplicates from the second filtered pool of fragmented users to generate the filtered panelists.

4. The computer-implemented method of claim 3, wherein the normalizing comprises transforming the collected and stored additional data from a text format into a distributed database that operates on transactions associated with the stored and collected additional data, and the cleaning comprises removing a portion of the stored and collected additional data that is not required, including data associated with incomplete transactions and duplicated data, to generate the cleaned, normalized data.

5. The computer-implemented method of claim 4, further comprising, after the normalizing and cleaning, classifying the cleaned, normalized data by analyzing descriptions of the transactions, and associating merchant identifiers with the corresponding descriptions, wherein an automated machine learning is applied to reach an accuracy, to generate classified data.

6. The computer-implemented method of claim 5, further comprising, for a panel comprising the filtered panelists, combining the classified data and third party data to generate initial forecasts that are assembled into a final forecast based on differences in consumer behavior associated with corresponding differences in revenue structure for the merchant identifiers, wherein the final forecast comprises a prediction of a future value of a parameter associated with the merchant identity, performing bias calculation of non-randomized panelists, and performing a correction to the initial forecasts based on the bias calculation.

7. The computer-implemented method of claim 6, further comprising detecting one or more anomalies for an output of each of the cleaning, the normalizing, the classifying and the generating, based on anomalies in a behavior of the merchant associated with the merchant identifier, and/or based on a statistical error of the additional data from the panelists.

8. The computer-implemented method of claim 1, wherein the raw data includes information about a date of a transaction, a location where the transaction was undertaken, a description of the transaction, a monetary amount of the transaction, how the transaction was paid for, and an identity of a person who undertook the transaction, and the raw data further comprises locational data, WiFi data, and website and application data.

9. A non-transitory computer readable medium having stored therein a program for making a computer execute a method of determining present or future trends, and providing a recommendation based on those trends, said program including computer executable instructions for performing the method comprising:
receiving raw data, wherein the raw data is data which has not been cleaned or normalized;
cleaning and normalizing the raw data;
creating historic data via machine learning;
comparing the cleaned and normalized data with the historic data;
generating a model based on the compared cleaned and normalized data and the historic data, wherein the model provides one or more determinations of the trend determines a recommendation; and
providing the one or more determinations to a recommendation engine or a user.

10. The non-transitory computer readable medium of claim 9, wherein the cleaning and normalizing the raw data further comprises:
receiving the raw data from one or more sources;
filtering the raw data based on particular rules; and
associating the raw data with particular metrics,
wherein if the filtered and associated data is determined to be relevant, the data is stored and used as the cleaned and normalized data, and
wherein if the filtered and associated data is determined to be irrelevant, the data is stored for future use, and the particular metrics include data associated with a particular stock or a plurality of stocks, a regional, national, or universal unemployment rate, public and not public company revenues and market shares, consumer behavior across several companies, electronic indices, restaurant indices, how particular sectors in the workforce are performing, inflation, and trends for mutual funds.

11. The non-transitory computer readable medium of claim 10, wherein the one or more sources comprises panelists, and the filtering comprises:
receiving a pool of fragmented users;
filtering the pool of fragmented users based on geolocation to remove one or more of the fragmented users until the pool of fragmented users is representative of a population distribution associated with a geographical unit, to generate a first filtered pool of fragmented users;
filtering the first filtered pool of fragmented users based on a stable number of transactions from a start date to an end date, to obtain a second filtered pool of fragmented users;
removing outliers and duplicates from the second filtered pool of fragmented users to generate the filtered panelists.

12. The non-transitory computer readable medium of claim 11, wherein the normalizing comprises transforming the collected and stored additional data from a text format into a distributed database that operates on transactions associated with the stored and collected additional data, and the cleaning comprises removing a portion of the stored and collected additional data that is not required, including data associated with incomplete transactions and duplicated data, to generate the cleaned, normalized data.

13. The non-transitory computer readable medium of claim 12, further comprising, after the normalizing and cleaning, classifying the cleaned, normalized data by analyzing descriptions of the transactions, and associating merchant identifiers with the corresponding descriptions, wherein an automated machine learning is applied to reach an accuracy, to generate classified data, and, for a panel comprising the filtered panelists, combining the classified data and third party data to generate initial forecasts that are assembled into a final forecast based on differences in consumer behavior associated with corresponding differences in revenue structure for the merchant identifiers, wherein the final forecast comprises a prediction of a future value of a parameter associated with the merchant identity, performing bias calculation of non-randomized panelists, and performing a correction to the initial forecasts based on the bias calculation.

14. The computer-implemented method of claim 13, further comprising detecting one or more anomalies for an output of each of the cleaning, the normalizing, the classifying and the generating, based on anomalies in a behavior of the merchant associated with the merchant identifier, and/or based on a statistical error of the additional data from the panelists.

15. The non-transitory computer readable medium of claim 6, wherein the raw data includes information about a date of a transaction, a location where the transaction was undertaken, a description of the transaction, a monetary amount of the transaction, how the transaction was paid for, and an identity of a person who undertook the transaction, and wherein the raw data further comprises locational data, WiFi data, and website and application data.

16.-22. (canceled)
